(19) United States
(12) Patent Application Publication
(10) Pub. No.: US 2026/0179497 A1
(43) Pub. Date: Jun. 25, 2026

(54) SYSTEM AND METHOD FOR GRAPH-BASED MULTI-AGENT DRONE COPILOT ORCHESTRATION OF SEARCH, DETECTION, AND RESCUE OPERATIONS

(71) Applicant: Ricardo Arteaga, Lancaster, CA (US)

(72) Inventor: Ricardo Arteaga, Lancaster, CA (US)

(21) Appl. No.: 19/438,572

(22) Filed: Jan. 1, 2026

Related U.S. Application Data
(63) Continuation-in-part of application No. 18/132,417, filed on Apr. 9, 2023, now Pat. No. 12,620,318.

(51) Int. Cl. G08G 5/80; G06Q 10/06

(52) U.S. Cl. CPC G08G 5/80; G06Q 10/06

(57) ABSTRACT

A system and method are provided for multi-agent orchestration of UAV-based search, detection, triage, and threat assessment missions. An Agentic AI subsystem coordinates specialist agents each implemented as a large language model (LLM) constrained by a GraphRAG (graph-based retrieval-and-gating) framework. Per-track sensor inputs including ROI imagery, multi-keypoint pose vectors, posture classifications, telemetry, and CLIP-based semantic similarity scores are fused into structured, schema-validated JSON records conforming to an AI-Agent Contract Schema. A conductor module performs latest-per-track fusion; an orchestrator routes fused states to specialist agents based on confirmed classifications. GraphRAG constraints enforce indicator logic and gate conditions prior to LLM inference. Outputs include triage priority, threat likelihood, uncertainty scores, and operator guidance. Inference may occur on UAV edge devices or be offloaded to ground compute systems with cross-validation. Outputs are rendered via a DroneChat GUI, enabling operator-in-the-loop escalation. The modular architecture supports plug-in specialist agents via contract-governed interfaces without altering core fusion or orchestration logic.

### CROSS-REFERENCE TO RELATED APPLICATIONS

This application is a Continuation-in-Part (CIP) of U.S. patent application Ser. No. 18/132,417 filed Apr. 9, 2023, entitled “AI Copilot System for Command and Inquiry in Aviation Systems,” and claims priority thereto under 35 U.S.C. § 120. This application also incorporates by reference, in its entirety, U.S. patent application Ser. No. 18/492,167, filed Sep. 30, 2025, entitled “SAVIOR: Aerial Threat and Triage System for Emergency Response”.

### BACKGROUND OF THE INVENTION

### 1. Field of the Invention

This invention relates generally to autonomous unmanned aerial vehicle (UAV) operations and, more particularly, to systems and methods for real-time, graph-based, multi-agent orchestration of AI-enabled search, detection, classification, threat assessment, triage, and operator-guided rescue missions in tactical environments.

### 2. Description of the Related Art

Prior systems, including AI copilots and virtual aviation assistants, have employed natural language processing (NLP), machine learning (ML), and human-machine interfaces (HMI) to assist pilots in situational awareness and decision-making. Such systems are generally designed for manned aircraft cockpit environments and focus on pilot advisory functions rather than autonomous mission orchestration. The DroneChat Copilot system described herein corresponds to, and may be implemented as an embodiment of, the AI Copilot System for Command and Inquiry in Aviation Systems described in the parent application, adapted for unmanned aerial vehicle (UAV) mission orchestration and ground-station operator interaction.

### SUMMARY OF THE INVENTION

In embodiments, the present invention provides a graph-based multi-agent UAV orchestration system for autonomous and semi-autonomous search, detection, and rescue operations in disaster or emergency environments. The invention integrates a ground-based Human-Machine Interface (HMI) with a cloud or edge-resident Agentic AI subsystem that coordinates a fleet of UAV aircraft through real-time semantic understanding, policy- and gate-enforced orchestration, triage reasoning, and operator feedback.

A human operator initiates a mission by entering a command or intent (e.g., “search for injured persons”) via a DroneChat interface. The HMI synthesizes an operator command context that includes intent semantics, operational parameters, search areas, and optional mission policies. This context is passed to an Agents Orchestrator, which supervises a collection of cooperating AI agents that perform semantic perception, multimodal data fusion, classification, triage evaluation, threat analysis, and response generation.

Each UAV platform includes a sensor suite (electro-optical and/or infrared cameras), an edge AI compute module, and segregated communications links: a Command-and-Control (C2) link for navigation and tasking, and a Telemetry/Media (TM) link for streaming imagery, inference data, and status updates to a ground station for persistent storage and downstream fusion.

During operation, a Perception Module evaluates regions of interest (ROI) images from corresponding Track IDs, estimates posture or pose, and infers semantic attributes (e.g., “person lying,” “unconscious,” “armed”). The Perception Module may execute on the ground station and on an edge AI compute module aboard the UAV. When edge deployment is enabled, low-latency Contrastive Language-Image Pre-training (CLIP)-based visual inference and pose classification can occur at the source, and results are transmitted back to the ground station for verification and fusion. In some embodiments this dual-location configuration allows semantic descriptors, such as visual match scores and object class embeddings, to be re-queried, quality-gated, and cross-validated between ground and edge for robustness and fault tolerance.

An AI-Agent Contract Schema governs inter-agent communication and data model normalization, defining standardized fields for track identifiers, timestamps, posture classifications, likelihood estimates, triage severity, threat levels, and recommended operator actions. These structured artifacts are exchanged between the DroneChat Conductor, AeroMedic Agent, Overwatch Agent, and other modules in JSON format and may further include evidence entries and clarification requests generated from a graph-based indicator policy.

The Agents Orchestrator manages coordination among:
DroneChat Agent: interprets operator intent and produces contextual responses.
DroneChat Conductor: performs per-Track ID fusion and state management.
Perception Module: executes semantic queries and posture validation.
AeroMedic Agent: computes triage severity and survivability.
Overwatch Agent: conducts risk and threat evaluation.
Graph-based indicator policy: enforces gates, thresholds, persistence rules, and operator prompt generation across agents.

The system classifies each detected subject using policy-enforced gates and thresholds applied to fused posture, motion, and semantic descriptors into one of three categories: Distress, Threat, or Normal. When critical thresholds are met, the system generates alerts, triage summaries, and recommended operator actions, such as “maintain 30 m altitude,” “mark point of interest,” or “initiate evacuation.” The results are stored in Fused JSON format conforming to the AI-Agent Contract Schema for auditability and post-mission review.

The DroneChat Graphical User Interface (GUI) presents fused mission data, including overlays, triage summaries, and semantic chat dialogs. The operator can issue follow-up queries, modify UAV commands, or relay location data to responders.

Through closed-loop coordination, the UAV adapts flight pathing and data collection in response to AI guidance and operator inputs, maintaining situational awareness and mission continuity. All semantic reports and fused outputs remain persistently stored for replay, validation, and evidence is indexed by Track ID and timestamp for audit and traceability.

Accordingly, the disclosed invention provides an end-to-end, explainable, graph-governed AI architecture that unifies perception, reasoning, and command into a cooperative system of UAVs and intelligent agents for real-time triage and search-and-rescue operations with safety gating and structured inter-agent outputs.

### BRIEF DESCRIPTION OF THE DRAWING(S)

Other objects, features, and advantages of the present invention will become apparent upon reference to the following description of preferred embodiments and to the accompanying drawings, wherein corresponding reference characters indicate corresponding parts throughout the several views of the drawings, and wherein:

FIG. 1 is a block diagram of a UAV search-and-rescue autonomy pipeline including a DroneChat Copilot human-machine interface, an agentic AI multi-agent subsystem, and a UAV platform with segregated Command-and-Control (C2) and Telemetry/Media (TM) links.

FIG. 2 depicts a high-level Concept of Operations diagram illustrating DroneChat Copilot-initiated search and rescue mission flow, including mission initiation, UAV scanning the search area for the detection, semantic evaluation of individuals, AI-driven triage determination, UAV guidance updates, and operator feedback loops.

FIG. 3 is a sequence diagram illustrating DroneChat Copilot multi-agent ground station execution during a UAV search and rescue mission, showing command initiation, orchestration, and coordinated agent responses.

FIG. 4A is an activity diagram illustrating initial mission activation and UAV link setup, including HMI engagement, system initialization, segregated C2 and TM link establishment, and initiation of semantic scan for targets.

FIG. 4B is an activity diagram illustrating per-Track ID fusion and agent routing, showing the processing loop for Track ID bundles, semantic parsing, state fusion, and triage task routing to specialist agents, including the AeroMedic Agent and Overwatch Agent.

FIG. 4C is an activity diagram illustrating multi-agent reporting and operator feedback, showing the final phase in which specialist outputs are fused, stored, and presented via the DroneChat GUI, including feedback from the agents and DroneChat Copilot-generated operator guidance.

FIG. 5 is a detailed internal block diagram illustrating the expanded system architecture, including the Memory System with Short-Term Memory, Long-Term Memory, and Memory Manager, as well as AI agent linkages, per-Track ID fusion engine DroneChat Conductor, and interfaces between perception, AI-Agent Contract Schema-validated JSON exchange, and UAV hardware, wherein TM and C2 data links are explicitly segregated.

FIG. 6 is an operator interface diagram illustrating exemplary user interface elements of the DroneChat GUI, including video stream, multi-pose target visualization, and a DroneChat dialog window displaying AI-generated responses and operator inquiries.

FIG. 7 depicts a system state diagram illustrating the unified operational state machine from system startup through HMI activation, semantic fusion, agentic triage, and UAV command dispatch, wherein the diagram emphasizes a recurring cycle for Track ID-based processing and fused JSON report generation.

FIG. 8 is a schematic diagram illustrating the AI-Agent Contract Schema and JSON exchange architecture. The figure depicts structured data handoff among agents, validation against schema definitions, and generation of fused reports returned to the Agents Orchestrator, including triage classifications and recommended operator actions.

### DESCRIPTION OF THE PREFERRED EMBODIMENT(S)

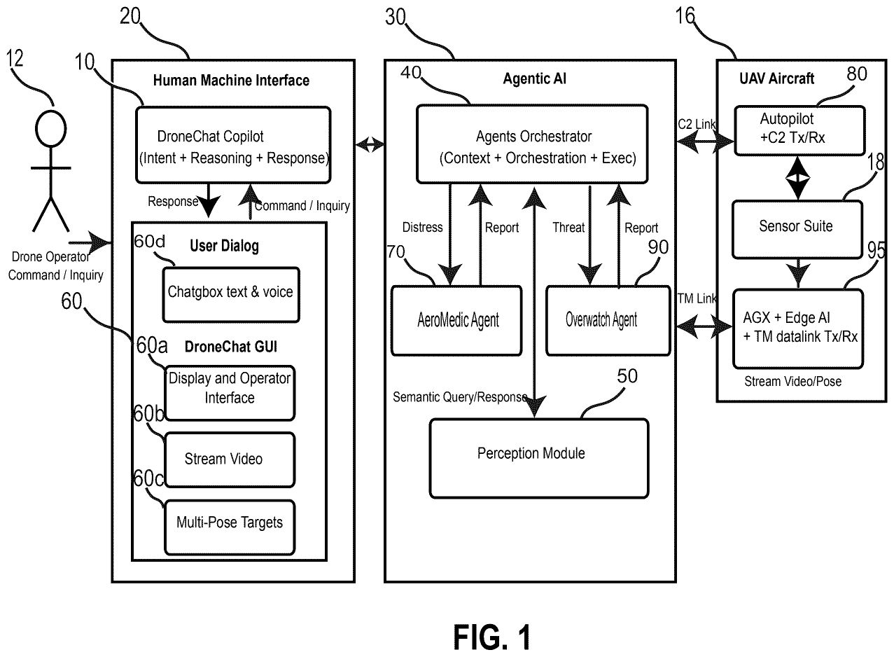

Referring now to FIG. 1, the invention comprises a multi-agent unmanned aerial vehicle (UAV) search, detection, and rescue system configured to support autonomous or semi-autonomous mission execution under operator supervision. The system integrates a Human-Machine Interface (HMI) 20, an Agentic Artificial Intelligence (AI) subsystem 30, and at least one UAV aircraft 16, which are communicatively coupled through bidirectional communication links to perform real-time perception, reasoning, and operational guidance.

An operator 12 interacts with the system through the Human-Machine Interface 20, which includes a DroneChat Copilot 10 configured to receive operator commands or inquiries, in natural language. The DroneChat Copilot 10 performs intent interpretation, contextual reasoning, and response generation, and exchanges information with a User Dialog 60d supporting text and voice interaction.

In certain embodiments, the DroneChat Copilot 10 functions as the intelligent agent and coordination layer of the Human-Machine Interface (HMI) and provides the primary interaction point for UAV mission control. The DroneChat Copilot 10 interfaces with the Agentic AI Subsystem 30 to receive structured, per-track outputs from the DroneChat Conductor 44 and specialist agents and transforms those outputs into operator-readable guidance and recommended actions presented through the DroneChat graphical user dialog 60d. The GUI 60 serves as the visual presentation layer, displaying fused track summaries, agent outputs, supporting evidence, and explainable rationales to enable closed-loop, operator-in-the-loop mission control.

In one operational embodiment, the DroneChat Copilot 10 generates concise, policy-constrained messages, referred to as brevity commands, to enhance pilot situational awareness and coordinated field response. These messages are derived from fused track-state data and specialist-agent outputs and are formatted in standardized aviation phrasing for clarity and consistency.

For example, following confirmation of a Critical triage classification by the AeroMedic Agent 70, the DroneChat Copilot 10 may issue the operator guidance message: “Maintain visual; coordinate ground team for immediate evacuation.”

This brevity command represents a policy-bounded advisory generated within the Copilot's safety framework, preserving human-in-the-loop authority while providing time-critical, explainable guidance consistent with mission context and operator protocols. In some embodiments, the DroneChat Copilot 10 comprises a retrieval-augmented large language model (RAG-LLM) based on a pretrained foundation model configured to generate mission guidance by combining (i) operator intent, (ii) retrieved operational knowledge and mission policies, and (iii) structured outputs from the conductor and specialist agents. The DroneChat Copilot 10 formats guidance using aviation tasking terminology, including aviate, navigate, and communicate to present prioritized recommendations in a pilot-familiar workflow. The DroneChat Copilot 10 may employ a chaining or tool-execution framework for retrieval, prompt construction, agent invocation, and response generation, without limitation to any specific software library or vendor implementation.

In certain embodiments, the DroneChat Copilot 10 is authorized to issue outer-loop guidance commands, including mission waypoints, altitude holds, and loiter patterns, through the Command-and-Control (C2) link. These outputs define navigation intent and mission objectives but do not engage in inner-loop flight stabilization or attitude control, which remain under the UAV autopilot module 80. The DroneChat Copilot 10 therefore governs mission-level “aviate, navigate, and communicate” logic while deferring continuous control surfaces, thrust, or stability functions to certified flight control firmware. This separation preserves operator authority and regulatory compliance while enabling AI-assisted mission orchestration.

The HMI 20 further includes a DroneChat Graphical User Interface (GUI) 60, comprising a display and operator interface 60a, a streamed video display 60b, and a multi-pose-target visualization panel 60c. These interface elements present live sensor data, detected targets, and AI-generated guidance to the operator, and enable follow-on queries or command inputs during mission execution.

The Agentic AI subsystem 30 is communicatively coupled to the HMI 20 and includes an Agents Orchestrator 40 responsible for managing context, coordinating subordinate AI agents, and executing task-level decisions. The Agents Orchestrator 40 receives interpreted operator intent and mission context from the DroneChat Copilot 10 and routes tasks and data accordingly.

Within the Agentic AI subsystem 30, a Perception Module 50 performs semantic query and response operations on incoming sensor data, including posture estimation, object recognition, and semantic attribute inference. The Perception Module 50 exchanges data with the Agents Orchestrator 40 and supports downstream reasoning by specialist agents.

The Agentic AI subsystem 30 further includes an AeroMedic Agent 70, configured to evaluate distress and injury-related indicators, and an Overwatch Agent 90, configured to evaluate threat, weapon presence, and situational risk. Each of these agents communicates bidirectionally with the Agents Orchestrator 40, providing structured reports corresponding to distress or threat assessments, respectively.

The UAV aircraft 16 includes an autopilot module 80 supporting command-and-control (C2) transmission and reception, and a sensor suite 18 comprising one or more imaging sensors, such as electro-optical or infrared cameras. The UAV aircraft 16 further includes an edge AI processing module 95, which performs onboard inference and manages a telemetry/media (TM) data link.

Drone Operator 12 intent interpreted by the DroneChat Copilot 10 is provided to the Agents Orchestrator 40, which issues navigation commands and tasking instructions over the C2 link to the UAV autopilot module 80, while the TM link streams video, pose data, and semantic inference results from the sensor suite 18 and edge AI module 95 back to the Agentic AI subsystem 30 for further processing.

In mission operation, the system enables a closed-loop interaction in which operator commands are interpreted by the DroneChat Copilot 10, coordinated by the Agents Orchestrator 40, informed by perception outputs from the Perception Module 50, and acted upon through guidance generated by the AeroMedic Agent 70 and Overwatch Agent 90, thereby enabling in adaptive UAV behavior and informed operator decision-making.

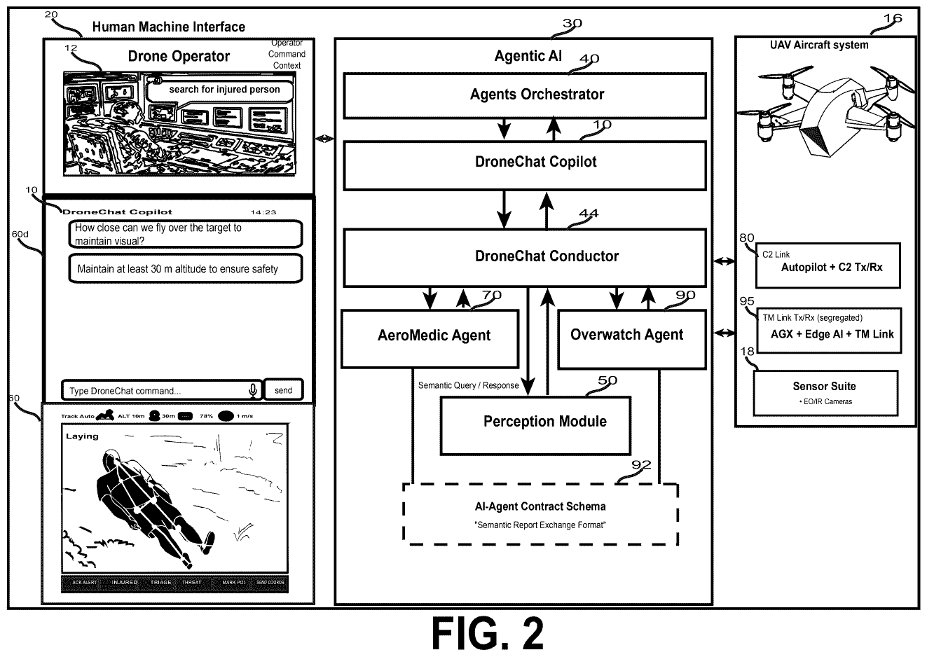

As shown in FIG. 2, the Drone Operator 12 interacts in real time with the DroneChat GUI 60, which displays live sensor video 60b, multi-pose target overlays 60c, and fused semantic labels per Track ID (for example, “Laying-INJURED (High)”), together with operator guidance generated by the DroneChat Copilot 10 (e.g., “Maintain at least 30 m altitude to ensure safety”). The operator may acknowledge alerts, enter follow-up natural-language inquiries via the user dialog 60d, mark a point of interest (POI), or issue further commands. This closed-loop interaction enables adaptive mission control, where AI recommendations and operator inputs jointly adjust observation geometry, Track ID prioritization, and downstream agent tasking.

In operation, the disclosed system executes the following sequence:
1. Mission initialization through the HMI 20, including generation of an operator command context by the DroneChat Copilot 10.
2. UAV sensing and edge inference on the UAV aircraft system 16 using the sensor suite 18 and edge AI module 95.
3. Segregated link operation, wherein the C2 link exchanges navigation/tasking with the autopilot 80 and the TM link streams video and inference artifacts to the Agentic AI subsystem 30.
4. Per-Track ID processing by the DroneChat Conductor 44 using semantic query/response with the Perception Module 50.
5. Agentic routing to specialist agents, including the AeroMedic Agent 70 for distress/triage and the Overwatch Agent 90 for threat/risk assessment.
6. Presentation of fused reports and operator guidance in the DroneChat GUI 60, and continuation of the loop until mission completion.

Through this integrated architecture, the invention provides an explainable, multi-agent AI system capable of autonomous perception, triage, and operator-assisted decision-making in complex search-and-rescue environments. Inter-module and inter-agent data exchanges are normalized using the AI-Agent Contract Schema 92, enabling consistent Track ID-based fusion, auditability of agent outputs, and deterministic handoff between the DroneChat Copilot 10, Agents Orchestrator 40, DroneChat Conductor 44, Perception Module 50, AeroMedic Agent 70, and Overwatch Agent 90, while preserving C2/TM link segregation for operational reliability.

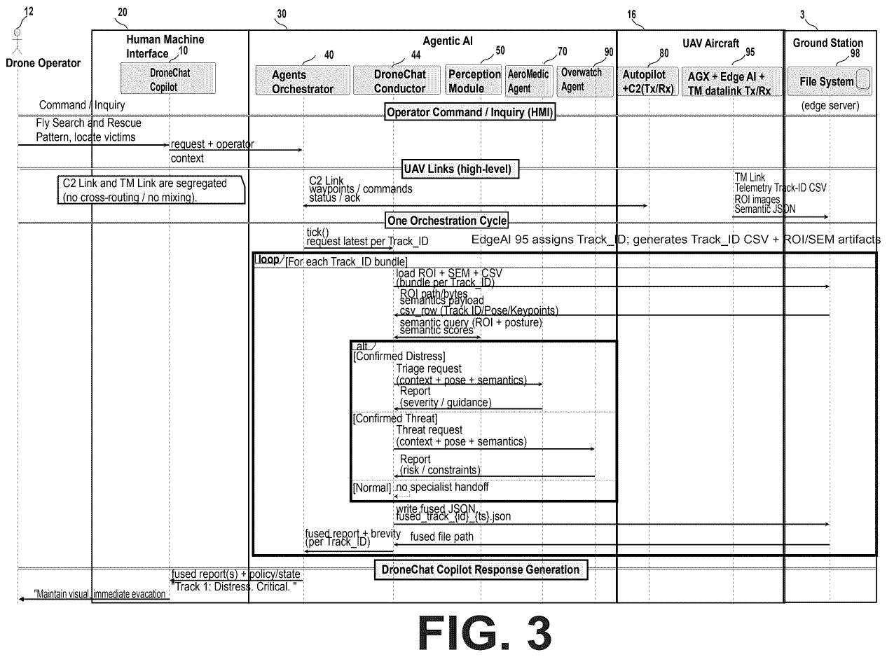

Referring now to FIG. 3, the invention further includes a deterministic, per-Track ID multi-agent orchestration sequence governing interaction among the Drone Operator 12, the Human-Machine Interface 20, the Agentic AI subsystem 30, the UAV Aircraft 16, and the Ground Station File System 98. FIG. 3 illustrates a time-ordered execution flow in which semantic perception, agent routing, and fused reporting occur within a bounded orchestration cycle.

The process begins when the Drone Operator 12 issues a command or inquiry through the User Dialog 60d or DroneChat GUI 60 of the HMI 20, such as “Fly search and rescue pattern, locate victims.” The DroneChat Copilot 10 interprets the operator's natural-language command and generates an operator command context including intent, constraints, and mission scope, which is transmitted to the Agents Orchestrator 40 for execution supervision within the Agentic AI subsystem 30.

The UAV Aircraft 16 operates using explicitly segregated communication channels, including a Command-and-Control (C2) link 86 and a Telemetry/Media (TM) link 96, with no cross-routing between links. The C2 link conveys waypoint commands, flight control instructions, and acknowledgment/status messages, while the TM link transmits sensor-derived data products, including Track_ID CSV records, region-of-interest (ROI) imagery, pose/keypoint data, and semantic JSON outputs generated by the onboard Edge AI module 95. These TM artifacts are delivered to the Ground Station File System 98 for indexed storage and downstream fusion.

At each orchestration cycle, represented by a tick( ) event, the Agents Orchestrator 40 requests the latest-per-Track ID bundle from the DroneChat Conductor 44. The DroneChat Conductor 44 performs a bounded scan of the file index, identifying available ROI, semantic (SEM), and CSV artifacts associated with each active Track_ID. For each Track ID bundle, the DroneChat Conductor 44 loads the ROI image, the semantic payload, and the corresponding CSV row, and issues a semantic confirmation query to the Perception Module 50, incorporating ROI content, posture classification, and pose-derived features.

Based on the semantic confirmation results: the DroneChat Conductor 44 applies rule-based routing logic and invokes one of three specialized execution pathways:
(a) Confirmed Distress: the AeroMedic Agent 70 receives a triage request containing posture, motion state, and semantic indicators, performs injury severity estimation and survivability reasoning, and returns a structured triage report;
(b) Confirmed Threat: the Overwatch Agent 90 receives a threat assessment request containing pose geometry, semantic cues, and contextual constraints, evaluates operational risk, and produces a threat and constraint report; or
(c) Normal: no specialist agent handoff occurs, and the Track ID is retained for continued observation.

Each completed Track ID evaluation results in generation of a Fused JSON record identified by fused_track_<track_id>_<timestamp>.json, containing the fused state, classification outcome, agent evidence, and recommended operator actions, and is written to persistent storage in the File System 98.

The fused Track ID reports are returned to the DroneChat Copilot 10, which generates concise, operator-facing natural-language responses and alerts derived from the structured agent outputs. Example guidance may include “Track 1: Distress:Critical:Immediate evacuation recommended” or “Threat detected: maintain standoff and request human review.”

These responses are rendered as visual overlays, chat messages, and alert indicators within the DroneChat GUI 60, closing the perception-reasoning-action feedback loop between the operator, the UAV, and the Agentic AI system.

Accordingly, FIG. 3 illustrates an end-to-end, Track ID-centric orchestration cycle in which detected subjects are independently analyzed, semantically classified, and routed to specialist agents, and reported with explainable evidence, while maintaining strict C2/TM link segregation to ensure mission safety, data integrity, and real-time responsiveness.

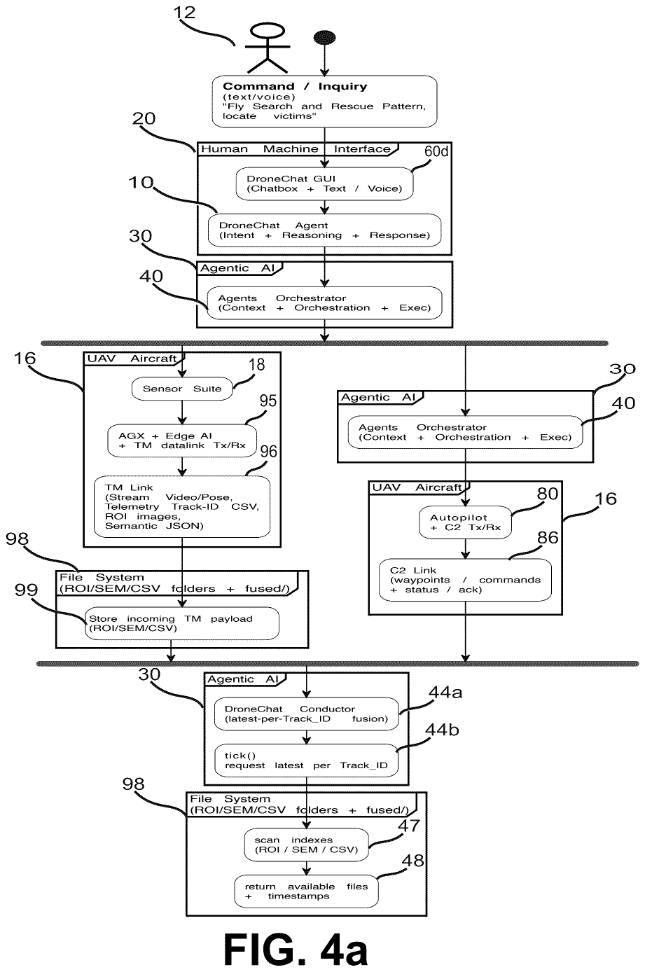

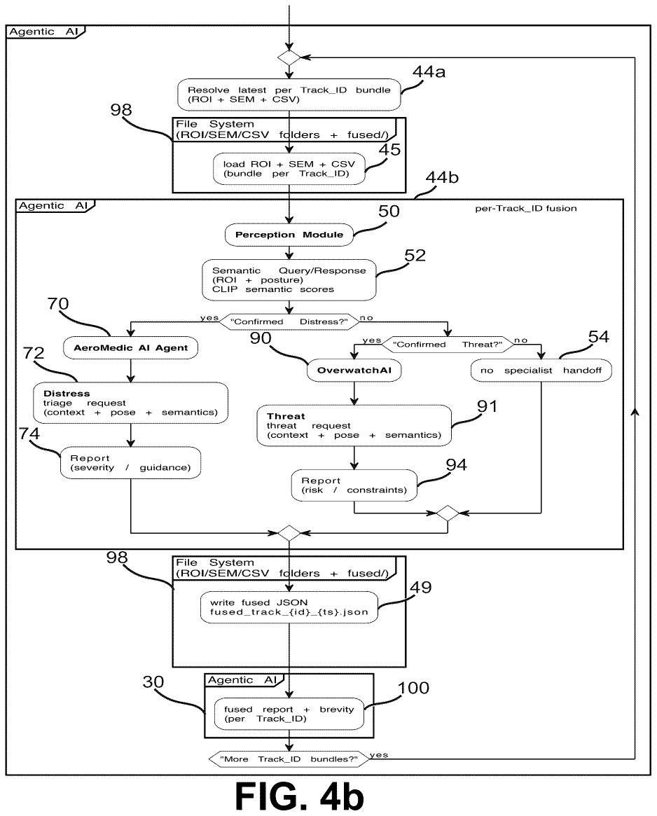

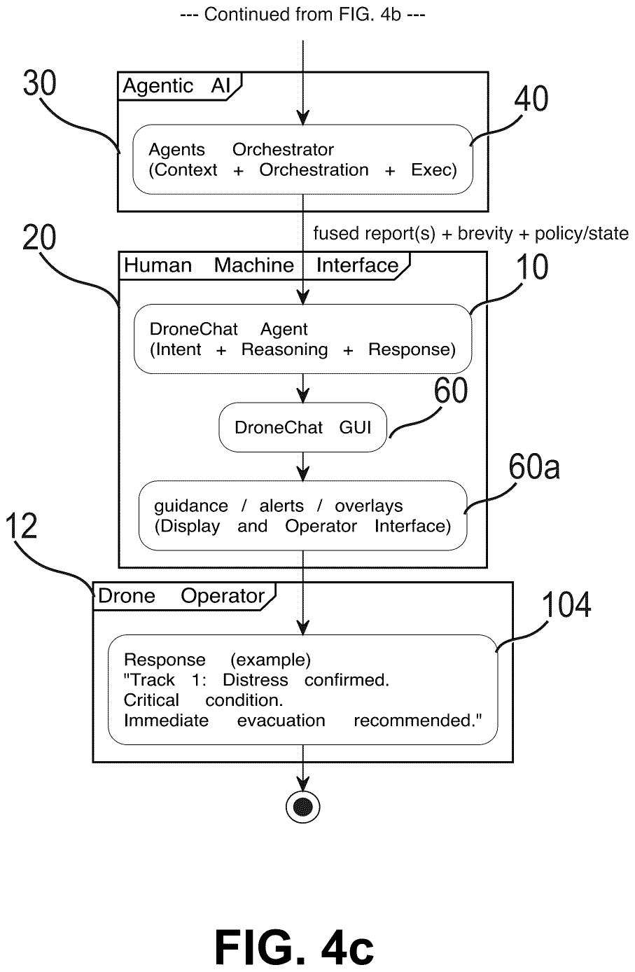

FIGS. 4A-4C collectively illustrate a staged, activity-driven operational workflow for a DroneChat Copilot-enabled, multi-agent UAV search-and-rescue system. FIG. 4A depicts mission activation and secure link establishment; FIG. 4B depicts per-Track ID fusion, classification, and specialist-agent routing; and FIG. 4C depicts multi-agent reporting, operator feedback, and closed-loop mission continuation.

Referring to FIG. 4A, the workflow begins when the Drone Operator 12 engages the Human-Machine Interface 20 to issue a mission command via the User Dialog 60d or DroneChat GUI 60. The DroneChat Copilot 10 performs intent extraction and contextualization of the natural-language command (e.g., “Initiate search for injured individuals within grid A3”) and forwards a structured operator command context to the Agents Orchestrator 40 within the Agentic AI subsystem 30.

The Agents Orchestrator 40 initiates mission setup by validating UAV availability, mission parameters, and link readiness, and establishes communication with the UAV Aircraft 16. A segregated Command-and-Control (C2) link 86 is verified for navigation and tasking commands, while an independent Telemetry/Media (TM) link 96 is verified for sensor data streaming. Upon successful link validation and authentication, the UAV Sensor Suite 18 commences data acquisition, generating electro-optical and/or infrared imagery for downstream perception and semantic processing.

Referring to FIG. 4B, the activity diagram illustrates a repeating per-Track ID fusion and routing cycle executed during mission operation. For each orchestration cycle, the DroneChat Conductor 44 retrieves, from the telemetry File System 98, a set of Track-ID-indexed artifacts, including region-of-interest (ROI) imagery, semantic (SEM) JSON outputs, and telemetry CSV records. The Conductor performs a “latest-per-Track ID” selection and fuses the retrieved artifacts into a unified per-track state, comprising location, posture, motion, and semantic attributes.

Based on predefined rule-based thresholds and fused semantic indicators, the Conductor classifies each track into one of three states: Distress, Threat, or Normal. If the track is classified as Distress, the fused per-track state is routed to the AeroMedic Agent 70 for triage evaluation; if classified as Threat, the state is routed to the Overwatch Agent 90 for risk and situational assessment; and if classified as Normal, no specialist handoff is performed. Each specialist agent returns a structured JSON result conforming to the AI-Agent Contract Schema 92, including assessment outputs, uncertainty indicators, and recommended operator actions. The DroneChat Conductor 44 serializes these results into persistent Fused JSON files 49 for audit, replay, and operator presentation.

Referring to FIG. 4C, the final activity stage depicts multi-agent reporting and operator-in-the-loop feedback. The DroneChat Copilot 10 aggregates one or more Fused JSON reports and generates concise, policy-aware summaries, identified as “fused report(s)+brevity+policy/state.” These summaries are transmitted to the DroneChat GUI 60a and rendered as visual overlays, alerts, and natural-language messages for the operator. Example outputs include triage alerts (e.g., “Track 1: Distress confirmed:Critical:Immediate evacuation recommended”) and operational guidance (e.g., “Maintain standoff altitude; mark point of interest”). The operator may acknowledge alerts, mark locations, or issue follow-up commands through the natural-language interface. Operator actions are fed back to the Agents Orchestrator 40, which updates mission state and policy context, enabling adaptive mission continuation across subsequent orchestration cycles.

Accordingly, as depicted across FIGS. 4A-4C together illustrate a closed-loop, explainable, and policy-constrained AI workflow, progressing from mission initiation and secure link establishment, through per-Track ID semantic fusion and specialist reasoning, to operator-guided decision support. This activity-driven architecture enables real-time UAV search-and-rescue operations with transparent reasoning, strict separation of control and telemetry channels, and persistent fused records for post-mission validation and analysis.

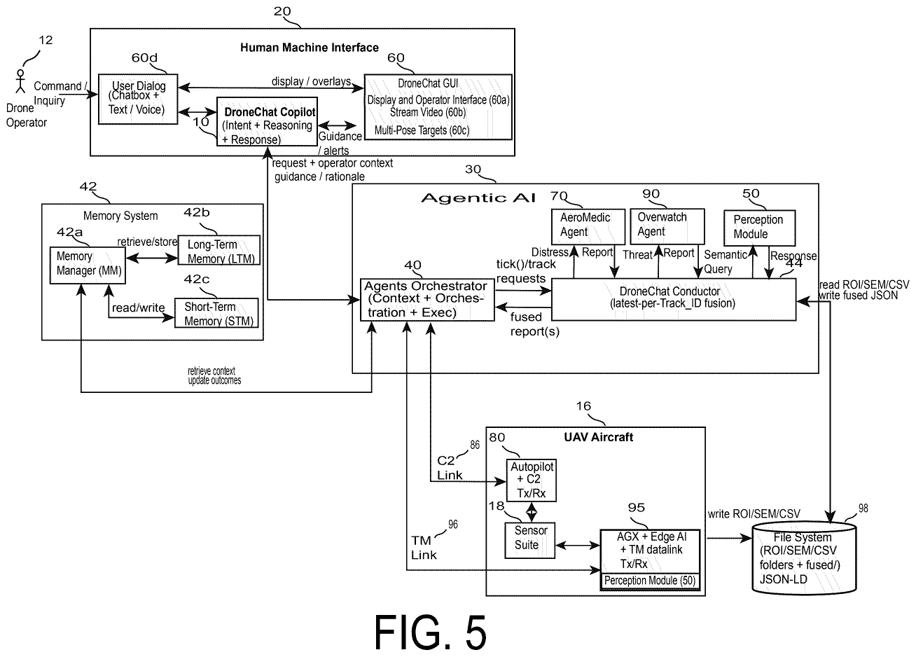

Referring now to FIG. 5, there is shown a detailed internal block diagram of the DroneChat Copilot 10 multi-agent search and rescue architecture, illustrating the data flow, control interfaces, and functional relationships among the major subsystems: the Human Machine Interface 20, the Agentic AI subsystem 30, the UAV Aircraft 16, the File System 98, and the Memory System 42.

The Human-Machine Interface 20 comprises a User Dialog 60d and a DroneChat

GUI 60 that provides multimodal communication with the Drone Operator 12. The User Dialog 60d supports both text and voice interaction, enabling operators to issue commands or queries and receive corresponding AI-generated responses. The GUI 60a-60c presents mission overlays, live video streams 60b, and multi-pose target visualization 60c. The DroneChat Copilot 10 interprets operator intent, formulates reasoning and responses, and relays mission context to the Agents Orchestrator 40 for execution across the Agentic AI subsystem 30.

The Memory System 42 includes a Memory Manager 42a, Short-Term Memory 42b, and Long-Term Memory 42c. The Memory Manager 42a oversees retrieval and storage operations between STM 42b and LTM 42c. Short-Term Memory 42b stores and retrieves short-term mission context, including current operator intent, recent Track ID state, recent fused reports, and active policy or safety state used during ongoing orchestration cycles. Long-Term Memory 42c stores and retrieves longer-horizon information, including prior mission outcomes, historical operator guidance, reusable semantic policies, and reference knowledge for subsequent missions or later stages of the same mission. Context retrieved from STM 42b and LTM 42c is used to inform subsequent reasoning cycles, and updated outcomes and decisions are written back to memory for persistence and audit.

Within the Agentic AI subsystem 30, the Agents Orchestrator 40 coordinates requests, context updates, and task execution among subordinate AI components, including the DroneChat Conductor 44, the Perception Module 50, the AeroMedic Agent 70, and the Overwatch Agent 90. The DroneChat Conductor 44 performs per-Track ID fusion, aggregating telemetry, semantic, and visual inputs into a unified fused report. The Perception Module 50 conducts semantic queries and returns classification responses. Fused reports are disseminated to the AeroMedic Agent 70 for triage assessment or to the Overwatch Agent 90 for contextual threat evaluation depending on the fused state and routing outcome. The DroneChat Copilot 10 receives fused report summaries and generates operator-facing guidance and alerts, while the underlying specialist agents remain non-operator-facing and return structured outputs.

The UAV Aircraft 16 includes an Autopilot 80 (configured with C2 Tx/Rx), a Sensor Suite 18, and an AGX+Edge AI 95 interfaced with TM datalink Tx/Rx. The C2 Link provides command exchange with the Autopilot 80, while the TM Link supports transfer of sensor-derived artifacts and inference outputs between the UAV Aircraft 16 and the Agentic AI subsystem 30.

The File System 98 is depicted as a shared repository comprising “ROI/SEM/CSV folders+fused/” and supports read/write access. The UAV side may write ROI/SEM/CSV, while the DroneChat Conductor 44 may read ROI/SEM/CSV and write fused JSON outputs to the fused directory, thereby preserving per-track fused records for later retrieval and review.

FIG. 5 further illustrates that operator-facing outputs flow back to the HMI as guidance/alerts and display/overlays, while internal system control proceeds via request+operator context, guidance/rationale exchanges, and fused report(s) produced by the DroneChat Conductor 44 and specialist agents.

Accordingly, FIG. 5 demonstrates the integrated architecture of the invention, showing how operator commands propagate through the DroneChat Copilot 10, the Agents Orchestrator 40, the DroneChat Conductor 44, the Perception Module 50, the AeroMedic AI Agent 70 and OverwatchAI 90, with the Memory System 42 and File System 98 providing persistent artifact exchange supporting explainable, per-Track ID fusion and reporting in real time.

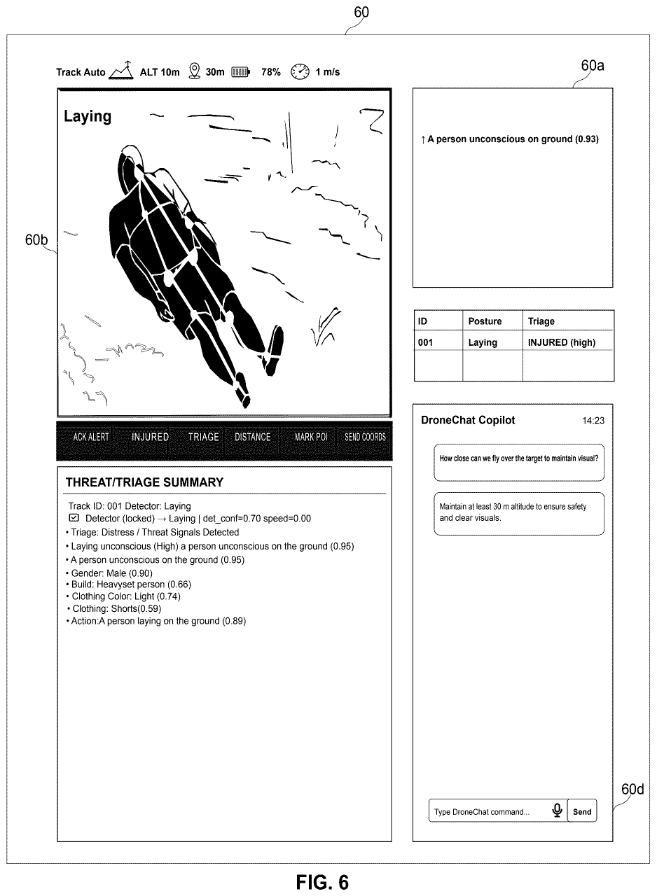

Referring now to FIG. 6, there is shown an embodiment of the DroneChat Graphical User Interface (GUI) 60 forming part of the Human-Machine Interface 20. The interface is configured to display fused perception data, specialist-agent assessments, triage summaries, and real-time operator guidance during a UAV search-and-rescue mission.

The GUI 60 comprises several coordinated panels. The Display panel 60b presents a live image or video feed from the UAV sensor suite, including pose-skeleton overlays and region-of-interest annotations identifying detected subjects. In the illustrated example, the system has locked onto Track ID 001, classified as Laying, with associated detector metadata (det_conf=0.70, speed=0.00). The visual overlay corresponds to a detected individual inferred to be lying motionless on the ground.

To the right of the display panel, an Agent Output and Brevity panel 60a presents concise, human-readable outputs generated by specialist agents, including the AeroMedic Agent 70 and, when applicable, the Overwatch Agent 90. In the illustrated example, the AeroMedic Agent outputs the statement “1 A person unconscious on ground (0.93),” representing a non-diagnostic medical triage inference derived from fused posture and semantic indicators. This panel is reserved for actionable agent conclusions and recommended next steps, rather than raw perception data.

The Threat/Triage Summary panel 60c provides a structured analytic breakdown for the active Track ID. This panel includes fused semantic indicators such as posture classification, distress or threat flags, inferred attributes (e.g., Gender: Male (0.90), Build: Heavyset (0.66), Clothing Color: Light (0.74), Clothing: Shorts (0.59)), and activity descriptors (Action: Laying (0.89)). The summary reflects fused outputs produced by the DroneChat Conductor 44 in coordination with the AeroMedic Agent 70 and formatted in accordance with the AI-Agent Contract Schema 92.

A per-track status table is displayed within panel 60a, listing Track ID, Posture, and Triage classification, such as “001|Laying|INJURED (High),” allowing operators to rapidly compare multiple detected subjects and their current triage states.

A user-interface (UI) control enables operator invocation of specialist AI agents and visualization of their reasoning outputs within the DroneChat Graphical User Interface (GUI) 60. Along the lower edge of the interface, a command toolbar provides quick-action controls labeled ACK ALERT, INJURED, TRIAGE, THREAT, MARK POI, and SEND COORDS, enabling the operator to acknowledge alerts, refresh per-track summary reporting, explicitly invoke specialist-agent analysis, mark points of interest, or transmit coordinates to responders with minimal interaction latency. The “TRIAGE” control is configured to generate or refresh the Threat/Triage Summary 60c for the currently selected Track ID using the latest fused per-track record produced by the DroneChat Conductor 44, including posture, detector outputs, semantic indicators, and current classification state. The “INJURED” control is configured to invoke the AeroMedic Agent 70 for the currently selected Track ID, causing a medical triage request to be issued via the Agents Orchestrator 40 and returning a structured triage result and/or brevity message for display in the agent output panel 60a. The “THREAT” control is configured to invoke the Overwatch Agent 90 for the currently selected Track ID, returning a risk and constraint assessment including an explainable natural-language rationale and supporting evidence for display in the agent output panel 60a, thereby allowing operator-directed escalation to threat review independent of routine triage summary refresh.

The DroneChat Copilot dialog panel 60d permits natural-language interaction between the operator and the DroneChat Copilot 10. In the illustrated example, the operator queries, “How close can we fly over the target to maintain visual?”, and receives an AI-generated response, “Maintain at least 30 m altitude to ensure safety and clear visuals.” This response reflects policy-aware guidance synthesized from fused agent outputs and mission safety constraints.

Accordingly, FIG. 6 illustrates an integrated operator interface in which raw perception 60b, structured analytic summaries 60c, and specialist-agent conclusions and brevity outputs 60a are clearly separated yet coherently presented. This arrangement enables explainable AI-to-human transparency, rapid decision-making, and human-in-the-loop control, thereby ensuring situational awareness, traceability, and actionable coordination during live UAV-based search-and-rescue operations.

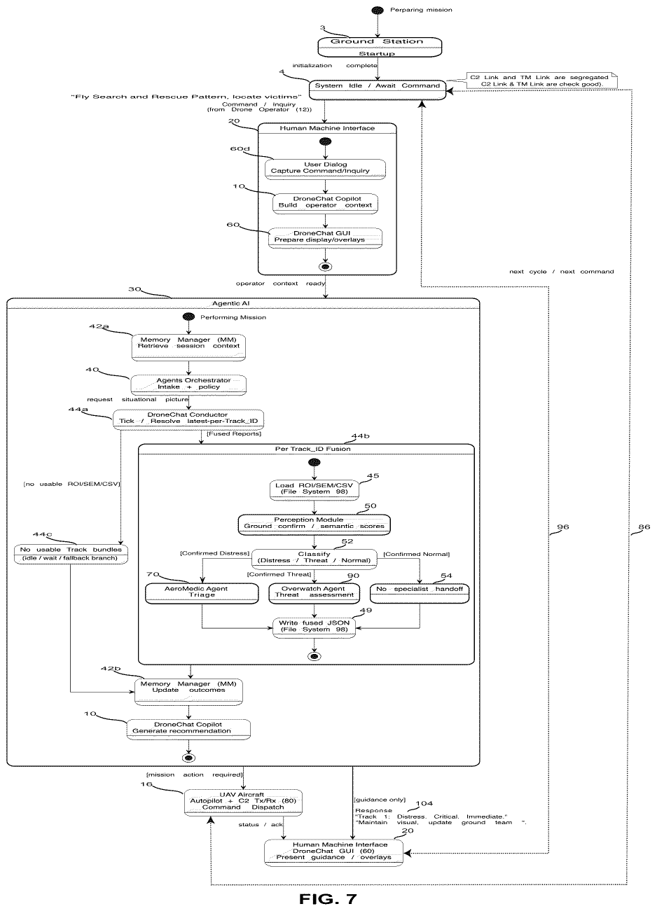

Referring now to FIG. 7, there is illustrated a unified System State Diagram depicting end-to-end control flow among the Ground Station 3, Human-Machine Interface 20, DroneChat Copilot 10, Agentic AI 30, and UAV Aircraft 16 subsystems. The diagram models the transition of system states from initialization and operator command input through per-Track ID fusion, Distress/Threat/Normal classification, specialist-agent routing, and UAV command dispatch.

At startup, the Ground Station 3 performs link integrity checks confirming that the Command-and-Control (C2) Link 86 and Telemetry/Media (TM) Link 96 are segregated and operational. Upon successful initialization, the system enters an Idle/Await Command state, awaiting operator input via the Human-Machine Interface 20.

When the Drone Operator 12 issues a command such as “Fly search-and-rescue pattern, locate victims” the User Dialog 60d captures the textual or spoken inquiry. The DroneChat Copilot 10 interprets mission intent and builds an operator command context, which is passed to the DroneChat GUI 60 for visual display preparation and overlay configuration. Once this context is ready, the system transitions into the Agentic AI 30 domain in Performing Mission state.

Within the Agentic AI subsystem 30, the Memory Manager (MM) 42a retrieves short-term session context from Short-Term Memory (STM) 42b and retrieves relevant historical or reference data from Long-Term Memory (LTM) 42c, enabling continuity across orchestration cycles. The Agents Orchestrator 40 then intakes policy and context and initiates execution via the DroneChat Conductor 44, which performs a recurring tick( ) Track request routine.

During each orchestration cycle, the DroneChat Conductor 44 evaluates whether usable Track bundles are available. If no usable ROI/SEM/CSV artifacts exist for any Track ID, the system enters a “No usable Track bundles” wait/fallback branch until new telemetry artifacts arrive. When Track bundles exist, the Conductor executes Per Track ID Fusion 44b by loading ROI/SEM/CSV artifacts from the File System 98 and issues a semantic confirmation query to the Perception Module 50 (e.g., “Ground confirm/semantic scores”).

The Perception Module 50 and Conductor 44 then produce or update a fused per-track state and classify each Track ID into one of three system states 52: Distress, Threat, or Normal. If Distress is confirmed, the Conductor routes the fused state to the AeroMedic Agent 70 for triage analysis. If Threat is confirmed, the Conductor routes the fused state to the Overwatch Agent 90 for threat assessment. If Normal is confirmed, no specialist handoff is required and processing continues. For each Track ID cycle, the Conductor writes a fused JSON record 49 to the File System 98, including the classification, any specialist-agent output, and supporting evidence in conformance with the AI-Agent Contract Schema 92.

Following each fusion-and-routing cycle, the Memory Manager (MM) 42a updates outcomes (e.g., track classifications, triage results, threat assessments, and operator actions) to maintain mission continuity across subsequent cycles. The DroneChat Copilot 10 then generates a recommendation or brevity guidance statement 104 based on the latest fused report(s), including policy/state constraints.

When a mission action is required, the system dispatches commands to the UAV Aircraft 16 via the Autopilot and C2 Transceiver 80 over the C2 Link 86 (e.g., loiter, altitude adjustments, waypoint updates). When guidance-only output is required, the system refrains from command dispatch and instead routes advisory content to the Human-Machine Interface 20. In both cases, the DroneChat GUI 60 presents guidance and overlays, enabling operator acknowledgment or follow-up commands and thereby closing the operational loop.

Accordingly, FIG. 7 illustrates the cyclical and closed-loop coordination between perception, reasoning, memory-backed context retrieval, and control within the disclosed multi-agent UAV system. The state diagram explicitly models initialization, data-availability fallback behavior, per-track fusion, agent task routing, fused-report persistence, and operator feedback, demonstrating how the invention achieves autonomous yet explainable orchestration of search-and-rescue missions.

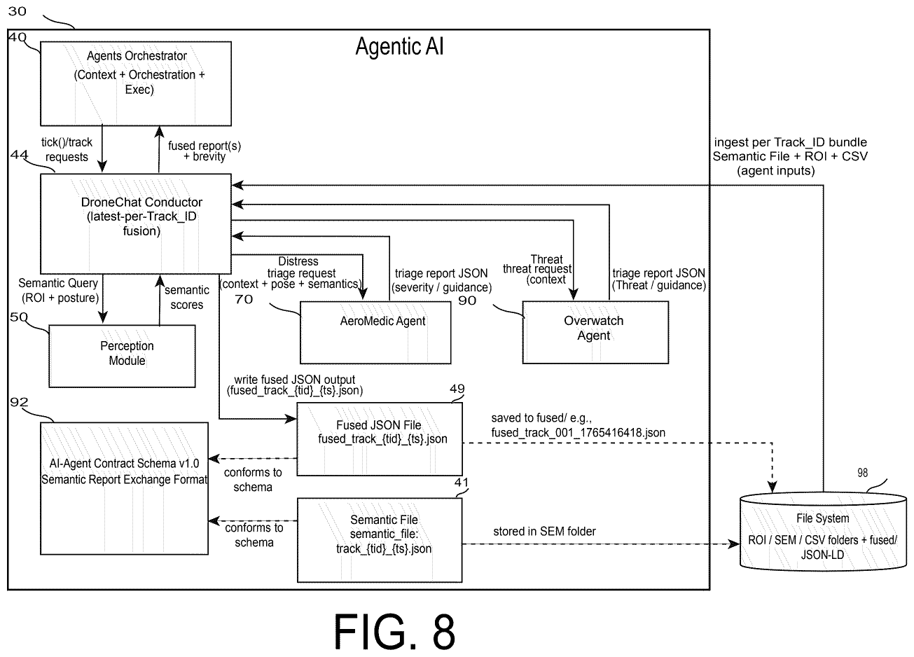

Referring to FIG. 8, an embodiment is shown of the AI-Agent Contract Schema 92 and its corresponding semantic and fused JSON exchange architecture, wherein each specialist agent operates under a graph-based retrieval-and-gating framework

(GraphRAG). The architecture governs interoperable data exchange among the Agentic AI subsystem 30, the File System 98, and associated AI agents, while enabling policy-constrained, explainable reasoning through graph-defined indicator, gate, and prompt nodes.

In the embodiment of FIG. 8, each specialist agent, including the AeroMedic Agent 70 and the Overwatch Agent 90, is implemented as a large language model (LLM) execution engine coupled to a graph-based retrieval system (GraphRAG retriever). The LLM provides probabilistic reasoning, natural-language generation, and structured inference capabilities, while the GraphRAG retriever supplies bounded, policy-governed knowledge in the form of indicator nodes, gate constraints, and operator prompt templates. The LLM does not operate in isolation; instead, its outputs are constrained and explainable by the graph-based retrieved context, supporting policy-constrained, auditable enforcement of safety, triage, and threat policies.

The File System 98 serves as a centralized, schema-governed repository containing graph-encoded knowledge artifacts, organizing Region-of-Interest (ROI) imagery, Semantic JSON files (semantic_file), telemetry CSV records, and Fused JSON outputs. Each semantic_file (e.g., track_{tid} _{ts}.json) is normalized and mapped into AI-Agent Contract Schema 92 fields and contains posture labels, detector outputs, semantic similarity scores, and quality metadata used as inputs to downstream GraphRAG reasoning.

The DroneChat Conductor 44 ingests per-track bundles from the File System 98 and performs latest-per-Track-ID fusion, producing a normalized per-track state that includes posture classification, pose geometry, motion features, and semantic indicators. This fused state is serialized as a Fused JSON File 49 and acts as the primary structured per-track state used for GraphRAG-based agent execution.

The Agents Orchestrator 40 coordinates execution within the Agentic AI subsystem 30, issuing tick( ) track( ) requests to the DroneChat Conductor 44 and routing fused per-track states to specialist agents. The Perception Module 50 provides semantic query responses and similarity scores, which are referenced, not blindly accepted, by downstream GraphRAG gate logic.

LLM-Based GraphRAG Specialist Agent Invocation

When a track is classified as Distress or Threat, the DroneChat Conductor 44 invokes the appropriate specialist agent using a GraphRAG-guided execution path. Each specialist agent is implemented as a large language model (LLM) coupled with a GraphRAG retriever, wherein the retriever supplies a task-specific subgraph comprising indicator nodes, gate definitions, and policy constraints, and the LLM evaluates the fused per-track state within those retrieved constraints.

Upon invocation, each specialist agent evaluates the fused per-track state against GraphRAG indicator nodes and enforces gate conditions (e.g., posture persistence, image quality thresholds, semantic corroboration requirements). Only indicators passing applicable gates contribute to the agent's output, ensuring fault tolerance, explainability, and conservative escalation. The resulting agent output is returned in JSON format conforming to the AI-Agent Contract Schema 92 and merged into the Fused JSON File 49. AeroMedic Agent-GraphRAG Medical Triage Reasoning

The AeroMedic Agent 70 operates as a non-diagnostic triage reasoning module implemented as an LLM with an associated GraphRAG retriever. The LLM performs probabilistic inference and structured output generation, while the GraphRAG retriever enforces posture-, motion-, and semantic-based triage rules through formal indicator and gate nodes.

AeroMedic reasoning is governed by formal GraphRAG gate nodes that enforce:
posture persistence requirements,
motion stability thresholds,
image-quality and keypoint-confidence gating, and
semantic cue corroboration rules.

Indicators failing gate criteria increase an uncertainty indicator and may trigger clarification requests rather than escalation.

Table 1 (AeroMedic AI Posture, Motion & Semantic Indicators) corresponds directly to GraphRAG indicator nodes, with each table row representing a retrievable indicator definition and its associated effects on triage priority, uncertainty, and operator prompts. The table therefore serves both as documentation and as a logical mapping of the policy-defined GraphRAG knowledge graph.

TABLE 1
AeroMedic AI Posture, Motion & Semantic Indicators (Laying, Sitting, Fetal Posture)

| | | | | Effect on Triage |
|---|---|---|---|---|
| | | | | Priority/ |
| Rank/ | What it | Inputs (Posture + 17 | Non-Diagnostic | Operator |
| Indicator | Measures | Keypoints + CLIP) | Interpretation | Prompts |
| 1. Posture | Laying vs | Posture classifier output + | Primary posture | Laying → higher |
| Class (Core) | Sitting | confidence; torso/hip/shoulder | indicator | priority candidate |
| | | geometry | | (context- |
| | | | | dependent); Sitting |
| | | | | → lower priority |
| | | | | candidate unless |
| | | | | corroborated by |
| | | | | other indicators |
| 2. Laying | Fetal-like vs | 17-keypoint geometry: knee | Protective/ | Fetal-like + |
| Subtype: | non-fetal | flexion, hip flexion, torso curl | guarding posture | persistence → |
| Torso | laying | proxy; side-lying proxy; | indicator (non- | elevate triage |
| Orientation | | persistence; optional CLIP | diagnostic) | priority estimate |
| Fetal | | “curled up/lying on side” cue | | modestly; tag |
| Position | | (auxiliary) | | “guarding |
| | | | | posture-confirm”; |
| | | | | prompt “Alternate |
| | | | | view/zoom” if |
| | | | | uncertain |
| 3. Whole- | Motionless | Keypoint displacement/velocity | Low- | Motionless + |
| Body Motion | vs | across N frames; motion | responsiveness | Laying + |
| Index | purposeful | consistency | indicator (non- | persistence → |
| | vs agitated | | diagnostic) when | high-urgency |
| | | | motionless + | candidate; prompt |
| | | | persistent | “Human review/ |
| | | | posture | continue |
| | | | | observation/mark |
| | | | | POI” |
| 4. Posture | Stable vs | Time-series of posture, motion, | Triage-indicator | Worsening trend |
| Persistence/ | improving vs | mobility, and semantic cue | trend (non- | → escalate |
| Trend | worsening | confidence | clinical) | priority; improving |
| | indicator | | | → |
| | trend | | | monitor/deprioritize |
| | | | | cautiously |
| 5. Lower- | Ambulatory/ | Hip-knee-ankle angles; | Mobility indicator | Immobile → |
| Limb | crawl-like/ | stance transitions; center-of- | Possible limb | elevate priority; |
| Mobility | immobile | mass translation proxy | deformity | crawl-like → |
| Lower | Non- | hip-knee-ankle angle; | indicator | moderate; |
| Limbs | physiologic | keypoint confidence; temporal | | ambulatory → |
| (Deformity | knee/ankle | persistence; optional CLIP cue | | lower unless |
| Indicator) | angle | on leg crop (“bent backwards”) | | trauma/blood cues |
| | persisting | | | present |
| | across | | | |
| | frames | | | |
| 6. Upper- | Protective | Elbow/wrist angles; limb | Protective vs | Reduced limb |
| Limb | posture vs | motion amplitude; symmetry; | reduced- | motion + Laying + |
| Voluntary vs | reduced | hand-to-torso distance | voluntary-motion | low global motion |
| Reduced | voluntary | | indicator (non- | → elevate priority; |
| Motion | motion | | diagnostic) | protective + |
| | pattern | | | purposeful |
| | | | | movement → |
| | | | | reduce priority |
| 7. | Persistent | Nose-neck vector angle; | Abnormal | Supporting |
| Head/Neck | abnormal | variance over time; head/neck | head/neck | escalation only; |
| Orientation | head/neck | keypoint confidence | orientation | increases |
| Stability | alignment | | indicator | uncertainty if low |
| | | | (requires | confidence; |
| | | | confirmation) | prompt |
| | | | | “Reacquire/ |
| | | | | alternate angle” |
| 8. Semantic | Visual | CLIP/VLM similarity for | Blood-like | If above threshold + |
| Cue: Blood- | semantic | “blood/bleeding”; optional | semantic cue | quality OK → |
| Like | evidence | region cue; quality gate | (unconfirmed) | elevate priority; |
| Staining | consistent | | | attach |
| (Unconfirmed) | with blood- | | | “unconfirmed- |
| | like red | | | confirm visually”; |
| | staining | | | prompt |
| | | | | “Zoom/closer pass |
| | | | | per policy” |
| 9. Semantic | Scene-level | CLIP/VLM similarity for | Trauma-context | Elevate priority |
| Cue: | evidence of | “wreckage/debris/accident/ | cue | when combined |
| Trauma | accident/ | injured”; scene semantics | (unconfirmed) | with |
| Context | injury context | | | Laying/immobility/ |
| (Unconfirmed) | | | | low motion; prompt |
| | | | | “Mark POI/share |
| | | | | coords/dispatch |
| | | | | responders” |
| 10. | Whether | Keypoint confidence, occlusion | Uncertainty | If quality below |
| Confidence | evidence | score, ROI resolution, | indicator + | thresholds → |
| & Quality | supports | viewpoint proxy, tracking | human-review | suppress high- |
| Gating | decisive | stability | flag | urgency |
| | output vs | | | escalation; output |
| | uncertain | | | “Uncertain- |
| | | | | reacquire/alternate |
| | | | | view”; request |
| | | | | additional ROI |
| | | | | imagery |

The AeroMedic Agent 70 outputs include structured JSON fields defining triage priority estimates, non-diagnostic condition descriptors, evacuation urgency categories, uncertainty indicators, clarification requests, and a concise inference rationale identifying which GraphRAG indicators and gate outcomes contributed to the decision.

Each output conforms to the AI-Agent Contract Schema 92 as illustrated in FIG. 8, ensuring field-level interoperability across the Agentic AI subsystem 30, File System 98, and DroneChat GUI 60.

In a representative operational embodiment, the AeroMedic Agent 70 implementation LLM was executed using the validated GraphRAG policy (JSON-LD) and Contract Schema 92. The resulting output conformed to all required schema fields, including:

```
{
  “injury_severity”: “Critical”,
  “likely_conditions”: [
    “possible major hemorrhage (unconfirmed)”,
    “possible unconscious trauma (non-diagnostic)”
  ],
  “recommended_interventions”: [
    “prioritize airway management and recovery position”,
    “dispatch responders for immediate assessment”
  ],
  “evacuation_priority”: “Immediate”,
  “survivability_probability”: 0.65,
  “uncertainty_indicator”: 0.2,
  “clarification_requests”: [
    {
      “type”: “clip_reprompt”,
      “target_region”: “full_body”,
      “query_terms”: [
        “confirm presence of visible blood”,
        “check for responsiveness”,
        “assess for additional injuries”
      ],
      “reason”: “indicator_needs_confirmation”,
      “requested_action”: “requery_clip_on_crop”
    }
  ],
  “evidence”: [
    {
      “indicator”: “InjuryVisible”,
      “score”: 0.872,
      “gate”: “pass”,
      “notes”: “High-confidence distress cue indicating potential severe injury.”
    },
    {
      “indicator”: “SemanticCue_BloodLike”,
      “score”: 0.255,
      “gate”: “fail_low_score”,
      “notes”: “Visible blood indicator present but below confirmation threshold.”
    }
  ],
  “rationale”: “Laying posture with visible injury and high distress confidence indicates a
critical situation. Immediate evacuation is warranted; further imagery is needed to confirm
the presence of blood and assess overall condition.”
}
```

This validated output demonstrates operational compliance between the AeroMedic Agent 70 source-code implementation and the AI-Agent Contract Schema 92. It confirms that GraphRAG-defined indicator and gate nodes (e.g., InjuryVisible, SemanticCue_BloodLike) were correctly applied, that uncertainty and clarification logic were enforced, and that all generated recommendations remained non-diagnostic, explainable, and policy-bounded in accordance with the safety and governance framework described in FIG. 8.

The Overwatch Agent 90 is activated exclusively for tracks with a confirmed Threat classification and is implemented as an LLM-Based GraphRAG retriever encoding threat, compliance, and rules-of-engagement logic. The LLM evaluates pose geometry, motion, and semantic inputs, while the GraphRAG retriever constrains escalation, downgrade, and human-review logic through gated threat indicators.

Overwatch Agent 90 evaluates fused pose geometry, motion vectors, CLIP/VLM semantic scores, and contextual metadata against GraphRAG indicator nodes representing weapon-handling postures, compliance poses, object-in-hand disambiguation, and temporal escalation patterns. Weapon-related threat escalation requires both pose-consistent geometry and gated semantic corroboration, preventing false positives.

Table 2 (Overwatch Agent Threat & Compliance Parameters) encodes the Overwatch GraphRAG logic, with each row corresponding to a posture or behavior pattern evaluated through pose geometry, semantic similarity, quality gating, and temporal persistence rules.

TABLE 2
Overwatch Agent Threat & Compliance Parameters

| | | CV Feature from | | |
|---|---|---|---|---|
| Body Region/ | Pose/Motion | 17 Keypoints + | Tactical | Contribution to |
| Pattern | Parameter | CLIP | Interpretation | Threat Decision |
| Two-Handed | Elbows flexed, | Arm | Two-handed aim/hold | High threat likelihood |
| Weapon Aim/ | arms aligned | vectors/angles | posture consistent | when (i) posture |
| Hold Pattern | or extended | from 17 keypoints + | with a long-gun or | persists across frames |
| | with two-hand | CLIP weapon- | two-hand weapon | and (ii) CLIP weapon- |
| | support | consistent | handling | consistent score ≥ |
| | | semantic score | | threshold and (iii) ROI |
| | | computed on a | | quality gates pass; |
| | | hand/weapon- | | otherwise, human- |
| | | region crop | | review-required or |
| | | (quality-gated, | | monitor |
| | | thresholded) | | |
| One-Handed | One arm | Arm extension + | One-handed aim | Elevate threat |
| Aim Pattern | extended; | torso rotation | posture consistent | likelihood when |
| | torso rotated | from 17 keypoints + | with handgun-style | posture persists and |
| | toward aim | CLIP weapon- | aiming | CLIP weapon- |
| | direction | consistent | | consistent score ≥ |
| | | semantic score | | threshold; ambiguous |
| | | on hand-region | | results → monitor + |
| | | crop (quality- | | request reacquire/ |
| | | gated) | | human review |
| Low-Ready vs | Weapon- | Arm pitch angle | Hold-orientation | Adjust threat |
| High-Ready | hand/arm pitch | relative to torso | indicator (not a | likelihood; increase |
| Orientation | higher vs | and optional | determination of | uncertainty if ground |
| Proxy | lower relative | ground/camera | intent) | reference is |
| | to torso | attitude estimate + | | unreliable; require |
| | | weapon- | | persistence + |
| | | consistent | | semantic |
| | | semantic cue | | corroboration for |
| | | when available | | escalation |
| Hands-Up | Arms above | Wrist elevation + | Compliance/surrender | Downgrade threat |
| Compliance | head; wrists | full extension | posture indicator | likelihood unless |
| Pose | elevated | from 17 | | weapon-consistent |
| | | keypoints; | | semantic score ≥ |
| | | optional hand- | | threshold; ambiguous |
| | | region semantic | | cases → human- |
| | | cue | | review-required |
| Object-in-Hand | Differentiate | CLIP similarity | Object-likelihood cue | Reduces false |
| Disambiguation | weapon-like vs | scores across | (semantic) | positives by |
| | phone/tool-like | classes (e.g., gun | | downgrading threat |
| | objects | vs phone vs tool) | | likelihood when non- |
| | | on hand/weapon | | weapon class |
| | | ROI + quality | | dominates; low- |
| | | gates | | confidence/ambiguous |
| | | | | → human-review- |
| | | | | required + reacquire |
| | | | | prompt |
| Rapid Closing/ | Approaching | Torso trajectory + | Closing-behavior | Elevate threat |
| Approach | rapidly vs | speed vector | indicator | likelihood only when |
| Behavior | moving away | (preferably | | combined with |
| | | stabilized/ground- | | weapon-consistent |
| | | referenced); | | cue (and/or aim |
| | | persistence | | posture) and motion |
| | | gating | | estimate is reliable; |
| | | | | otherwise increase |
| | | | | uncertainty |
| Prone Active | Laying posture | Prone + | Prone threat- | High-threat candidate |
| Threat vs | with active | elbow/arm | candidate vs distress- | when (pose + |
| Distress | aim-like limb | geometry + | candidate | weapon-consistent |
| Candidate | geometry vs | head/torso | | cue) persist; |
| | low motion | motion vs low- | | otherwise, route as |
| | | responsiveness | | distress candidate |
| | | indicator; optional | | when low- |
| | | weapon- | | responsiveness |
| | | consistent cue | | indicator persists |
| | | | | (non-diagnostic) |
| Cover/ | Peeking/partial | Occlusion metrics + | Concealment | Increase uncertainty; |
| Concealment | occlusion | partial pose + | behavior indicator | may increase threat |
| Context | behind object | semantic cue | | likelihood when |
| (optional) | | | | combined with |
| | | | | weapon-consistent |
| | | | | cue; prompt |
| | | | | “reacquire/alternate |
| | | | | angle” |
| Group | Multiple | Multi-person | High-consequence | Increase uncertainty; |
| Formation/ | nearby | keypoint graph + | context amplifier | recommend standoff |
| Crowd Context | individuals and | proximity/cluster + | | observation; human- |
| | occlusion | occlusion | | review-required when |
| | | | | weapon-consistent |
| | | | | cues occur in crowded |
| | | | | scenes |
| Temporal | Threat | Threat history | Temporal smoothing | Prevents single-frame |
| Escalation/ | rising/falling | vector + | for operator latency | escalation; supports |
| De-escalation | over time | persistence | | controlled de- |
| Logic | | counters + | | escalation; ties threat |
| | | hysteresis | | state changes to |
| | | thresholds | | persistence + |
| | | | | corroboration rules |

Overwatch Agent 90 outputs include: threat level, threat type labels, recommended operator actions, human-review-required flags, uncertainty indicators, and a full inference rationale explicitly referencing the contributing GraphRAG indicators and gate outcomes.

Schema-Validated Overwatch Agent 90 Output Example and GUI Integration In one verified implementation, the Overwatch Agent 90 was invoked automatically following detection of a weapon-consistent semantic cue. The agent produced the following schema-validated JSON output, generated by the operational OverwatchAI module and stored in the File System 98:

```
{
  “threat_level”: “High”,
  “threat_likelihood_estimate”: 0.85,
  “threat_types”: [“confirmed_armed_threat”],
  “recommended_actions”: [“maintain standoff”, “hold orbit”, “request human review”],
  “need_human_review”: true,
  “uncertainty_indicator”: 0.0,
  “clarification_requests”: [ ],
  “evidence”: [
    {
      “indicator”: “WeaponConsistentCue”,
      “score”: 0.903,
      “gate”: “pass”,
      “notes”: “High confidence in weapon handling based on semantic analysis.”
    }
  ],
  “rationale”: “The individual is standing and is assessed to be holding a gun with high
confidence. Immediate precautionary measures are warranted, and human review is
necessary.”
}
```

When the Drone operator 12 selects the “THREAT” control (see FIG. 6), this detailed output is retrieved and rendered in panel 60a of the DroneChat GUI 60, displaying both the explainable rationale and supporting evidence list. This interface enables operator-directed review and acknowledgment of AI-derived threat assessments, ensuring human-in-the-loop control and verifiable explainability under the AI-Agent Contract Schema 92.

In one embodiment, the GraphRAG knowledge graph utilized by the AeroMedic Agent 70 and Overwatch Agent 90 is stored and loaded in a machine-readable JSON-LD format in the File System 98. Each node corresponds to a policy-governed indicator, gate, or prompt definition referenced at runtime by the agents' retrievers. A representative excerpt is shown below:

```
{
  “@context”: {
    “name”: “http://schema.org/name”,
    “requires”: “http://schema.org/requires”,
    “Gate”: “http://example.org/graphrag/Gate”,
    “Indicator”: “http://example.org/graphrag/Indicator”,
    “OperatorPrompt”: “http://example.org/graphrag/OperatorPrompt”
  },
  “@graph”: [
    {
      “@id”: “Indicator:SemanticCue_BloodLike”,
      “@type”: “Indicator”,
      “name”: “Semantic cue consistent with blood-like staining”,
      “requires”: [“clip_semantics.visible_blood”],
      “threshold”: 0.8,
      “onPass”: {
        “action”: “elevate_triage_priority”,
        “notes”: “visible_blood cue above threshold and quality gate passed”
      }
    },
    {
      “@id”: “Gate:QualityGate_ROI”,
      “@type”: “Gate”,
      “requires”: [“roi_quality”],
      “condition”: “roi_quality >= 0.5”,
      “onFail”: {
        “action”: “increase_uncertainty”,
        “requested_action”: “request_additional_roi_imagery”
      }
    },
    {
      “@id”: “OperatorPrompt:ReacquireLowQuality”,
      “@type”: “OperatorPrompt”,
      “text”: “Request alternate angle or higher-resolution image of ROI”,
      “trigger”: “Gate:QualityGate_ROI.onFail”
    }
  ]
}
```

Each node is uniquely addressable by its @id and includes deterministic fields defining requirements, gating conditions, and resulting policy actions. The GraphRAG retriever loads the applicable subgraph per track, evaluates indicator and gate nodes against fused UAV perception data, and passes only those nodes satisfying the defined conditions to the LLM reasoning engine. This declarative JSON-LD representation ensures that all AI reasoning steps remain bounded, auditable, and explainable under the AI-Agent Contract Schema 92.

All AeroMedic and Overwatch outputs conform to the AI-Agent Contract Schema 92, ensuring consistent field names, data types, and structural layout across agents. Outputs are serialized into the Fused JSON File 49 and stored in the File System 98 for auditability, replay, and downstream consumption.

The DroneChat Copilot 10 retrieves fused outputs and renders them through the DroneChat GUI 60, displaying:
concise agent brevity or action summaries in panel 60a,
detailed Threat/Triage summaries in panel 60c, and
full rationales on operator demand (e.g., via the INJURED and THREAT control).

Accordingly, FIG. 8 illustrates a GraphRAG-governed, contract-driven multi-agent reasoning architecture in which specialist agents perform explainable, policy-constrained inference over fused UAV perception data, while preserving modularity, fault tolerance, and operator trust.

In further embodiments, the system supports integration of additional domain-specific specialist agents beyond the AeroMedic Agent 70 and the Overwatch Agent 90. The modular architecture of the Agentic AI subsystem 30, in conjunction with the AI-Agent Contract Schema 92 and, in some embodiments, a GraphRAG-defined indicator, gate, and prompt framework, enables the substitution, augmentation, or addition of specialist agents to perform mission-specific inference tasks without modification to the core Conductor 44 fusion logic, Orchestrator 40 routing logic, or DroneChat Copilot 10 (HMI) presentation workflow.

By way of non-limiting example, additional agents may include a Fire Detection Agent configured to analyze electro-optical or thermal imagery for indicators such as flame, smoke, or localized heat anomalies, or a Hazardous Materials Agent configured to detect chemical or environmental hazards such as container leakage, placard markings, or personal protective equipment.

Each such agent exchanges structured inputs and outputs conforming to the AI-Agent Contract Schema 92, including track metadata, region-of-interest (ROI) references, semantic or sensor-derived indicators, and standardized output fields such as condition labels, severity levels, recommended operator actions, uncertainty indicators, and rationale. The Agents Orchestrator 40 invokes, schedules, and logs all agents using a uniform, contract-governed interface, thereby preserving auditability, interoperability, and consistent operator interaction across mission domains.

What is claimed is:

1. A system for orchestrating unmanned aerial vehicle (UAV) operations for search, detection, and rescue assistance, comprising:
a. at least one UAV comprising:
(i) a sensor payload configured to generate imagery and telemetry data;
(ii) a command-and-control (C2) transceiver configured to receive navigation or tasking commands; and
(iii) a telemetry/media (TM) interface configured to transmit the imagery and telemetry data;
b. a human-machine interface (HMI) comprising a DroneChat Copilot implemented as a large-language-model (LLM) intelligent agent, configured to:
(i) receive operator intent and mission input;
(ii) process structured outputs from the orchestration subsystem and specialist agents;
(iii) generate policy-constrained operator guidance, brevity messages, or outer-loop navigation intents; and
(iv) present mission outputs including classifications, rationales, and recommended operator actions through a graphical user interface (GUI);
c. a perception subsystem configured to generate, for each detected subject, a unique track identifier and inference artifacts including at least a posture classification and associated confidence;
d. a data store configured to persist, for each track identifier, a bundle comprising region-of-interest (ROI) imagery, telemetry, and inference artifacts;
e. an orchestration subsystem comprising:
(i) a conductor module configured to select a latest-per-track bundle, fuse the bundle into a per-track fused state, determine a confirmed classification, and serialize the fused state into a structured record conforming to an AI-Agent Contract Schema; and
(ii) an orchestrator module configured to route the per-track fused state to one specialist agent based on the confirmed classification;
f. a plurality of specialist agents comprising a triage agent and a threat-assessment agent;
g. wherein each specialist agent comprises a large-language-model (LLM) constrained by a graph-based retrieval-and-gating framework (GraphRAG) enforcing indicator and gate conditions prior to output generation;
h. wherein outputs of the specialist agents are structured, schema-validated JSON records; and
i. wherein the orchestration subsystem issues commands to the UAV via the C2 transceiver based on the structured outputs.

2. The system of claim 1, wherein the GraphRAG framework retrieves indicator and gate definitions from an external machine-readable JSON-LD knowledge graph stored in the data store.

3. The system of claim 1, wherein the AI-Agent Contract Schema defines required fields including a track identifier, timestamp, posture, confidence, confirmed classification, uncertainty indicator, and recommended operator action.

4. The system of claim 3, wherein schema validation failures result in record quarantine and automatic error annotation.

5. The system of claim 1, wherein the triage agent generates non-diagnostic triage priority estimates, evacuation urgency categories, and uncertainty indicators.

6. The system of claim 5, wherein the triage agent issues clarification requests when GraphRAG gate conditions are not satisfied.

7. The system of claim 1, wherein the threat-assessment agent outputs a threat likelihood estimate, threat type label, and a human-review-required indicator.

8. The system of claim 7, wherein threat escalation requires both pose-consistent geometry and gated semantic object verification.

9. The system of claim 1, wherein inference artifacts include a skeletal pose vector generated by a multi-keypoint pose estimator.

10. The system of claim 9, wherein the skeletal pose vector comprises a 17-keypoint representation, and the triage agent derives triage priority from posture persistence and whole-body motion across multiple frames.

11. The system of claim 1, wherein the perception subsystem performs inference on an edge compute device aboard the UAV.

12. The system of claim 11, wherein inference is additionally performed on a ground-based compute device and cross-validated against the edge inference results, and discrepancies trigger human-review flags or ROI reacquisition.

13. The system of claim 1, wherein the C2 transceiver and TM interface are segregated communication channels.

14. The system of claim 1, wherein the conductor module enforces timestamp skew and completeness constraints when selecting latest-per-track bundles.

15. The system of claim 14, wherein completeness requires ROI imagery, posture classification, and geolocation metadata.

16. The system of claim 1, wherein only one specialist agent is invoked per track per orchestration cycle.

17. The system of claim 16, wherein distress-classified tracks are routed to the triage agent and threat-classified tracks are routed to the threat-assessment agent.

18. The system of claim 1, wherein structured records are stored with append-only logging or cryptographic hashes to support mission replay and audit.

19. The system of claim 1, wherein the HMI allows manual selection of a track identifier to display corresponding evidence indicators and rationale produced by the invoked specialist agent.

20. A method for orchestrating UAV-based search and rescue assistance, comprising:
(a) receiving operator intent via a human-machine interface including a DroneChat Copilot agent implemented as a large-language-model (LLM) intelligent agent;
(b) receiving imagery and telemetry from a UAV over a telemetry/media link;
(c) generating per-track bundles comprising ROI imagery, telemetry, and inference artifacts;
(d) fusing latest-per-track bundles into per-track fused states;
(e) validating the fused states against an AI-Agent Contract Schema;
(f) routing each fused state to a single GraphRAG-constrained LLM specialist agent;
(g) enforcing indicator and gate conditions prior to output generation;
(h) receiving schema-validated JSON outputs including classifications, rationales, and recommended actions;
(i) displaying the recommended actions via the HMI; and
(j) optionally issuing UAV commands over a command-and-control link based on the recommended actions.
